(19) United States
(12) Patent Application Publication
(10) Pub. No.: US 2013/0273412 A1
(43) Pub. Date: Oct. 17, 2013

(54) BATTERY PACK AND VEHICLE INCLUDING THE SAME

(71) Applicants: Wataru Okada, Kobe-shi (JP); Shinsuke Nakamura, Kobe-shi (JP); Tomoyuki Ohmura, Kakogawa-shi (JP); Akinobu Wakabayashi, Kobe-shi (JP)

(72) Inventors: Wataru Okada, Kobe-shi (JP); Shinsuke Nakamura, Kobe-shi (JP); Tomoyuki Ohmura, Kakogawa-shi (JP); Akinobu Wakabayashi, Kobe-shi (JP)

(21) Appl. No.: 13/882,568

(22) PCT Filed: Oct. 28, 2011
(86) PCT No.: PCT/JP2011/074946

§ 371 Date: Jun. 24, 2013

(30) Foreign Application Priority Data
Oct. 30, 2010 (JP) 2010244859

(51) Int. Cl. H01M 2/34

(52) U.S. Cl. CPC H01M 2/34
USPC 429/158

(57) ABSTRACT

A battery pack includes battery cells, bus bars, and a wire harness. The battery cells include terminals on the upper surfaces of the battery cells. The bus bars connect the terminals of the battery cells to each other with the plurality of battery cells being arranged side by side. The wire harness is connected to the terminals. An electrically insulating separation wall is arranged between the terminal and the wire harness.

### BACKGROUND OF THE INVENTION

1. Field of the Invention

The present invention mainly relates to a battery pack that can be used as power supplies or the like for electric motor for driving vehicles such as hybrid cars and electric cars, and a vehicle including this battery pack.

2. Description of the Related Art

Electric cars and hybrid cars are known. Electric cars are driven by an electric motor. Hybrid cars are driven by an electric motor and an internal-combustion engine. These types of cars include a power supply device that includes battery cells accommodated in an exterior case. In order to provide enough power to drive the cars by means of an electric motor, such a power supply device includes a number of battery cells that are serially connected to each other for increasing the output voltage. For example, a battery pack is constructed of battery cells that have a rectangular box exterior container and are arranged side by side. The power supply device is constructed of a plurality of thus-constructed battery packs that are connected to each other (for example, see Japanese Patent Laid-Open Publication Nos. JP 2010-15949 A and JP 2008-243412 A).

Each of the battery cells includes positive/negative terminals that protrude from the battery cell upper surface. Each battery cell includes a sealing plate. The terminals are secured to the sealing plate with the terminals being electrically insulated from each other. In the battery pack, a number of thus-constructed battery cells are arranged side by side with electrically-insulating separators being interposed between the battery cells adjacent to each other. End plates are arranged on the end surfaces of the battery cells that are arranged on the outermost sides. Thus, the battery cells are securely held between the end plates. The end plates are coupled to each other through metal bind bars so that the battery cells are securely held in the side-by-side arrangement. The adjacent battery cells are electrically connected to each other through bus bars that are attached by screws or welded by laser to the terminals of the adjacent battery cells. In order to prevent that the battery cells are over-charged/over-discharged, the battery pack detects voltages of the battery cells and determines charged/discharged states of the battery cells. To detect cell voltages of the battery cells, a wire harness is connected to the terminals of the battery cells so that the battery cells are connected to a voltage detector circuit through the wire harness in the battery pack.

In addition, in order to prevent the short circuit between the adjacent terminals and to protect the terminals, the battery pack includes a terminal cover that covers the upper surface of the battery pack.

However, the known terminal cover merely covers the terminals. The wire harness is not fastened in the terminal cover. Accordingly, the wire harness is movable. In particular, in the case where the battery pack is used for vehicles, vibrations or shocks may bring the wire harness in contact with the terminals. If such friction or rubbing damages electrically insulating coating, there may be a possibility that the terminals are short-circuited at the worse.

On the other hand, when the terminal cover is attached, the wire harness may be caught between the terminal cover and the battery pack upper surface, which may damage the wire harness.

The present invention is aimed at solving the above problem, and its main object is to provide a reliability-improved battery pack that can prevent contact between a wire harness and terminals, and a vehicle including this battery pack.

### SUMMARY OF THE INVENTION

To achieve the above object, a battery pack according to a first aspect of the present invention includes a plurality of battery cells, bus bars, and a wire harness. The battery cells include terminals on the upper surfaces of the battery cells. The bus bars connect the terminals of the battery cells to each other with the plurality of battery cells being arranged side by side. The wire harness is connected to the terminals. An electrically insulating separation wall is arranged between the terminal and the wire harness.

According to the thus-constructed battery pack, since the electrically insulating separation wall is arranged between the terminal and the wire harness, the wire harness is not brought into direct contact with the terminals. For this reason, the coating of the wire harness will not be damaged by the terminals. As a result, such a damaged wire harness will not short-circuit the terminals. Therefore, there is a feature that the battery pack has improved reliability.

In a battery pack according to a second aspect of the present invention, a harness accommodation portion can be provided which accommodates the wire harness.

According to this construction, since the wire harness is accommodated in the harness accommodation portion, it is possible restrict movement or wobbling caused by vibrations, and the like. Therefore, it is possible to further reduce wear caused by rubbing.

In a battery pack according to a third aspect of the present invention, the harness accommodation portion can have an opening window.

According to this construction, it is possible to visually check the accommodated state of the wire harness in the harness accommodation portion through the opening window from the outside, and to surely check whether the wire harness is caught or not in assembling, for example. As a result, the safety can be ensured when the wire harness is connected. Therefore, the battery pack can have improved reliability.

In a battery pack according to a fourth aspect of the present invention, the electrically insulating separation wall can have a curved part corresponding to the terminal.

According to this construction, since the electrically insulating separation wall is formed in a curved shape as viewed in plan view, there is an advantage that the curved wall allows dimensional deviations and the like of wire harnesses.

In a battery pack according to a fifth aspect of the present invention, the electrically insulating separation wall and the harness accommodation portion can be integrally formed as a harness cover.

According to this construction, when the harness cover is attached onto the upper surface of the battery pack, the electrically insulating separation wall and the harness accommodation portion can be provided. As a result, the structure of the battery pack can be simple. Therefore, the battery pack is advantageous for ease of assembling and cost.

In a battery pack according to a sixth aspect of the present invention, the electrically insulating separation wall can be connected to an edge of the opening window, and the electrically insulating separation wall can have an inclined part that is inclined relative to the upper surface of the battery cell.

According to this construction, it is possible to easily visually check the accommodated state of the wire harness in the harness accommodation portion through the opening window from the outside. In addition, it is possible to easily guide the wire harness so as not to be caught by the electrically insulating separation wall when the harness accommodation portion is attached.

In a battery pack according to a seventh aspect of the present invention, the electrically insulating separation wall can have a curved part that is arranged on an end of the harness accommodation portion and formed in a curved shape as viewed in plan view.

According to this construction, the wire harness can be curved at the end of the harness accommodation portion so that the wire harness can be guided outward of the harness accommodation portion.

In a battery pack according to an eighth aspect of the present invention, a plurality of electrically-insulating separators can be provided which are interposed between the battery cells adjacent to each other, and the harness cover can be coupled to the separators.

According to this construction, since the separators have a coupling structure for coupling the harness cover, the harness cover can be easily position in place when coupled to the separators.

A vehicle according to a ninth aspect of the present invention includes the aforementioned battery pack.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view of a battery pack according to an embodiment of the present invention.

FIG. 2 is an exploded perspective view showing the battery pack shown in FIG. 1 with harness covers being removed.

FIG. 3 is a plan view showing the battery pack shown in FIG. 2.

FIG. 4 is an exploded perspective view showing the battery pack shown in FIG. 1.

FIG. 5 is a vertical cross-sectional view showing the battery pack shown in FIG. 1.

FIG. 6 is an exploded perspective view showing the side-by-side arrangement of a battery cell and separators.

FIG. 7 is a perspective view showing the harness cover of the battery pack shown in FIG. 2.

FIG. 8 is a bottom perspective view showing the harness cover shown in FIG. 7.

FIG. 9 is a bottom view showing the harness cover shown in FIG. 7.

FIG. 10 is a plan view showing a battery pack according to another embodiment of the present invention.

FIG. 11 is an enlarged perspective view showing a part of the battery pack shown in FIG. 10.

FIG. 12 is a perspective view showing a harness cover of the battery pack shown in FIG. 10.

FIG. 13 is a bottom perspective view showing the harness cover shown in FIG. 12.

FIG. 14 is a plan view showing a battery pack according to another embodiment of the present invention.

FIG. 15 is an enlarged perspective view showing a part of the battery pack shown in FIG. 14.

FIG. 16 is a perspective view showing a harness cover of the battery pack shown in FIG. 14.

FIG. 17 is a block diagram showing a hybrid car as a vehicle according to an embodiment of the present invention, which is driven by an internal-combustion engine and an electric motor.

FIG. 18 is a block diagram showing an electric vehicle as a vehicle according to another embodiment of the present invention, which is driven only by an electric motor.

### DETAILED DESCRIPTION OF THE EMBODIMENT(S)

The following description will describe embodiments according to the present invention with reference to the drawings. It should be appreciated, however, that the embodiments described below are illustrations of a battery pack and a vehicle including this battery pack to give a concrete form to technical ideas of the invention, and a battery pack and a vehicle including this battery pack of the invention are not specifically limited to description below. It should be appreciated that the members shown in claims attached hereto are not specifically limited to members in the embodiments. Members same as or similar to those of this invention are attached with the same designation and the same reference numerals and their description is omitted. In addition, a plurality of structural elements of the present invention may be configured as a single part that serves the purpose of a plurality of elements, on the other hand, a single structural element may be configured as a plurality of parts that serve the purpose of a single element.

A battery pack according to the present invention can be mainly used for power supply devices of vehicles, and is suitable as power supplies for supplying electric power to an electric motor of electric vehicles such as hybrid cars, which are driven by both an internal-combustion engine and an electric motor, and electric vehicles, which are driven only by an electric motor. A battery pack according to the present invention can be also used for vehicles other than hybrid car and electric car.

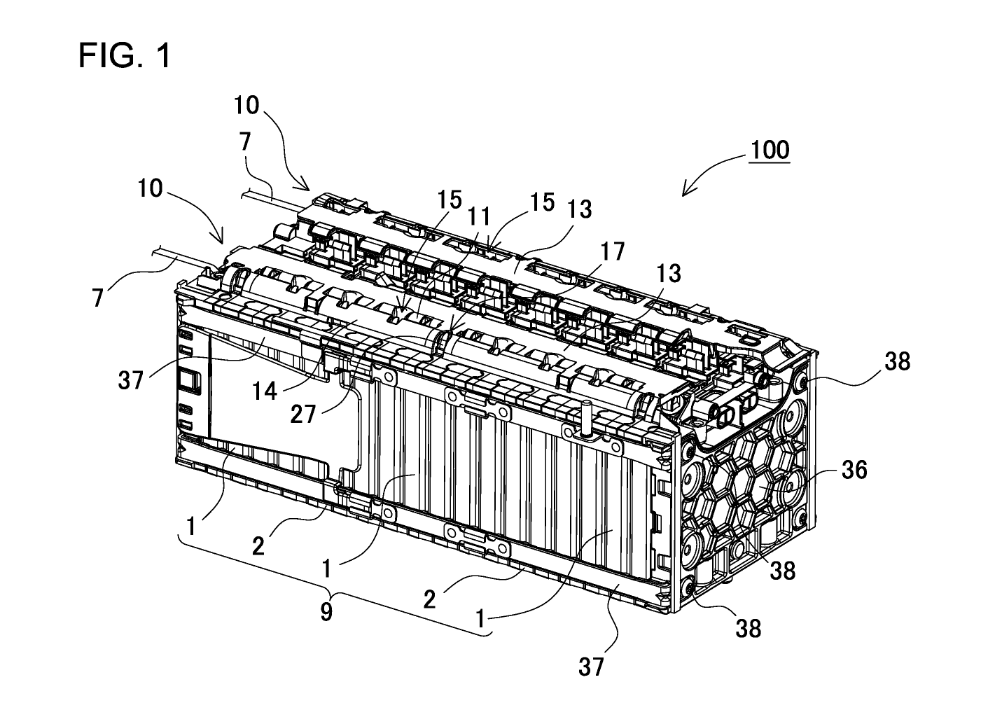

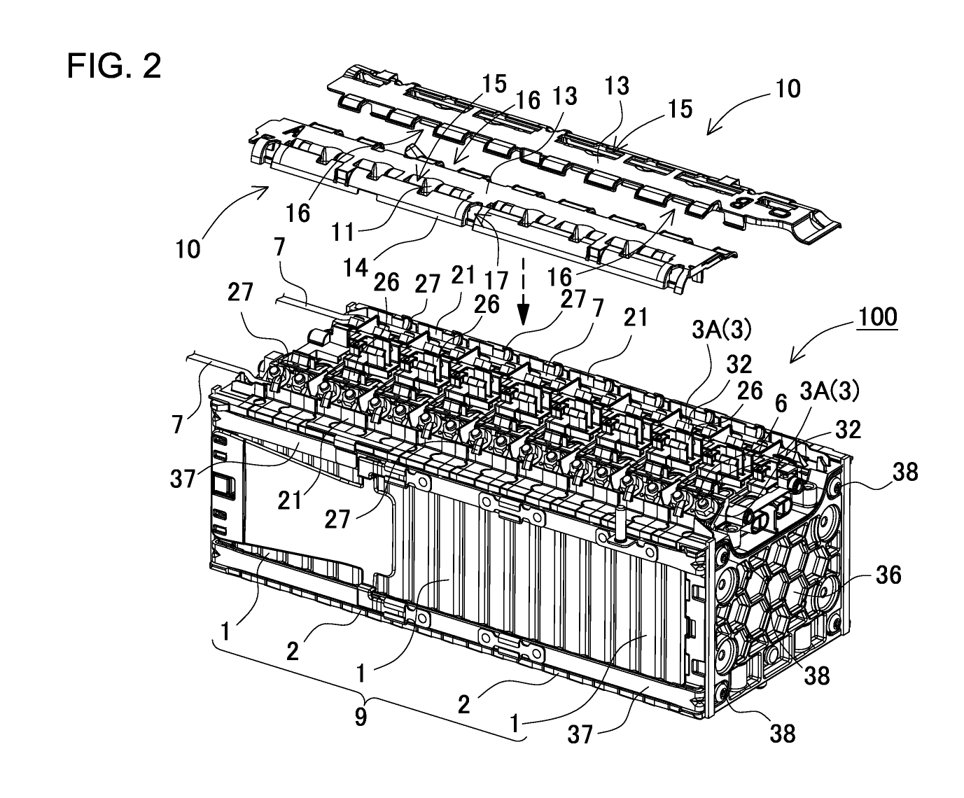

In a battery pack 100 shown in FIGS. 1 to 5 includes a plurality of battery cells 1. The battery cells are arranged side by side as a battery block 9, and electrically insulated from each other.

### (Battery Cell 1)

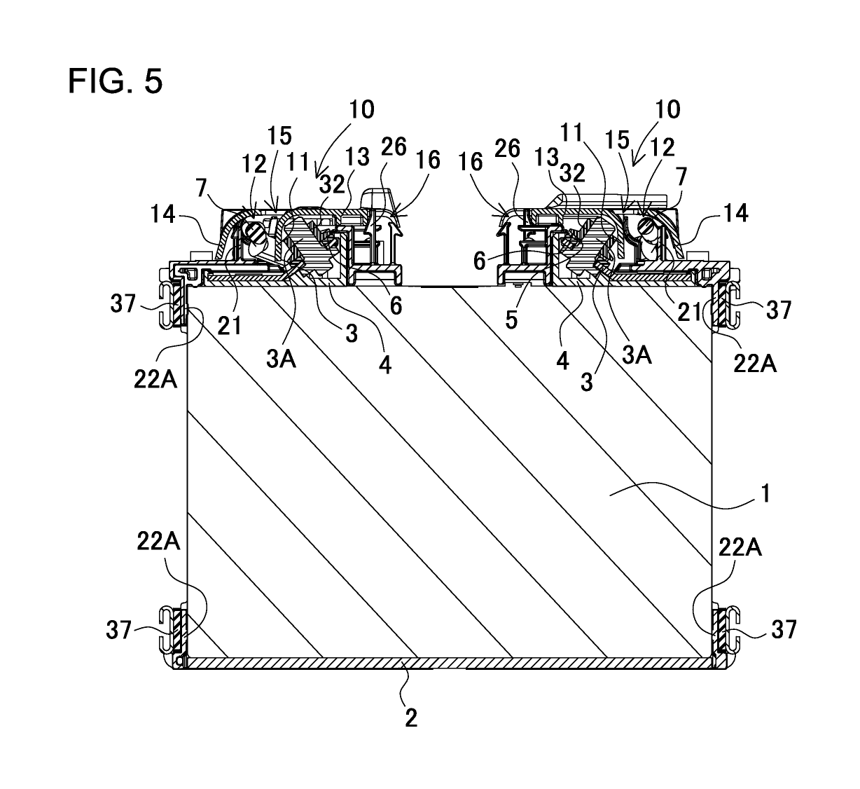

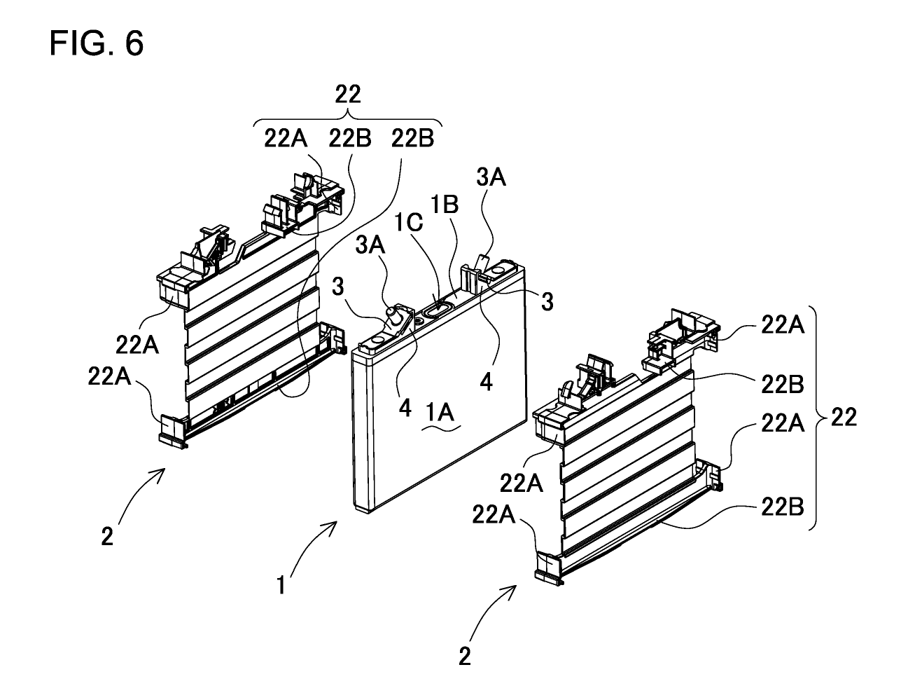

The battery cell 1 is a thin rectangular-box shaped battery the thickness of which is smaller thinner than the width. The battery cells 1 are arranged in parallel to each other. Separators 2 are interposed between the battery cells 1. The separators 2 electrically insulate the battery cells from each other so that the battery cells can be arranged side by side. Positive/negative terminals 3 are secured to and protrude from the both side parts of the upper surface of the battery cell 1, as shown in FIGS. 5 and 6. The positive/negative terminals 3 protrude from symmetrical positions with respect to a line. According to this construction, in the case where the battery cells 1 are arranged side by side with being flipped from side to side, the positive and negative terminals 3 of one of the battery cells are serially connected to the negative and positive terminals of another battery cell adjacent to the one of the battery cells by metal plate bus bars 6. Alternatively, the positive and negative terminals of one of the battery cells can be directly serially connected to the negative and positive terminals of another battery cell adjacent to the one of the battery cells. In the case of the battery pack in which the battery cells 1 are serially connected to each other, the output voltage of the battery pack can be high, and as a result the battery pack can provide high power. Note that, in the battery pack according to the present invention, battery cells adjacent to each other may be connected both in parallel and serial to each other.

The battery cell 1 is a lithium-ion rechargeable battery. However, the rectangular-box-shaped battery is not limited to a lithium-ion rechargeable battery. Any rechargeable batteries (e.g., nickel metal hydride batteries) can be also used. The rectangular battery cell includes electrode members of positive/negative electrode plates that overlap each other. After the electrode members are accommodated in an exterior container 1A, the exterior container is filled with an electrolytic solution and is airtightly sealed. The exterior container 1A is formed of an upwardly opened rectangular box shape the top opening of which is airtightly closed by a sealing plate 1B, as shown in FIG. 6. The exterior container 1A is formed by subjecting metal plate (e.g., aluminum or aluminum alloy) to deep drawing. The surface of the exterior container has electrical conductivity. The battery cells 1 to be arranged side by side are formed in a thin rectangular box shape. The sealing plate 1B is also formed from a metal plate such as aluminum or aluminum alloy. The positive/negative electrode terminals 3 are secured to the both side parts of the sealing plate 1B. Terminal holders 4 are interposed between the terminals and the sealing plate.

### (Terminal Holder 4)

The terminal holder 4 has a right triangular shape having a hypotenuse (inclined surface). The terminal holder electronically insulates the peripheral parts of the terminal 3 except the protruding part of the terminal, which protrudes from the upper surface of the battery cell 1. The terminal holder 4 is formed of an electrically-insulating material such as plastic. The terminal 3 is arranged in the inclined surface of the terminal holder 4. The terminals 3 are arranged at predetermined positions in the both end parts of the battery cell 1 with protruding in the inclined orientation. The positive/negative terminals 3 are connected to the positive/negative electrode plates (not shown), which are accommodated in the exterior container.

### (Bus Bar 6)

The terminals 3 of the battery cells 1 are connected to each other through the bus bars 6. A fastening screw 3A is secured to the terminal 3, and is inserted into the bus bar 6. A nut 32 is threadedly engaged with the fastening screw 3A. Thus, the bus bar is fastened to the terminal 3. The bus bar 6 is a metal plate, which has through holes on the both end parts of the bus bar. The through holes receive the fastening screws 3A of the terminals 3 of the battery cells 1 adjacent to each other. The bus bar 6 is arranged on the terminals 3. The bus bar 6 electrically connects the terminals 3 of the adjacent battery cells 1 to each other. The connection pattern between the terminals of the adjacent battery cells 1 depends on serial connection or parallel connection. That is, in the case of serial connection, the positive terminal of one of the adjacent battery cells is connected to the negative terminal of the other of the adjacent battery cells. In the case of parallel connection, the positive and negative terminals of one of the adjacent battery cells are connected to the positive and negative terminals of the other of the adjacent battery cells, respectively. In the illustrated battery pack 100, the terminals 3 of the adjacent battery cells 1 are serially connected to each other by the bus bars 6.

### (Detection Terminal 5)

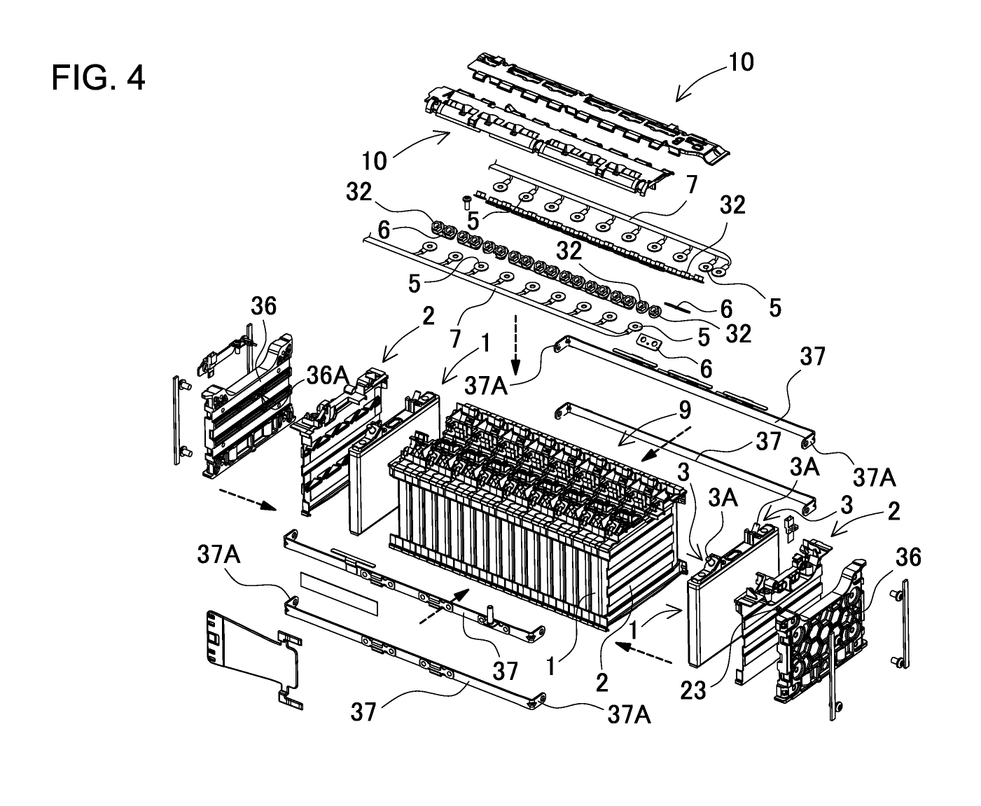

The battery pack 100 includes detection terminals 5 that are connected to the terminals 3 of the battery cells 1. Voltages and the like of the battery cells 1 can be detected through the detection terminals. The detection terminals 5 are connected to a circuit board (not shown) that includes a protection circuit for detecting voltages and the like of the battery cells 1 through wire harnesses 7. In order to detect voltages of the battery cells 1, the detection terminals 5 are connected through the wire harness 7 to the circuit board (not shown). The detection terminal 5 shown in FIG. 4 is a ring-shaped terminal that is coupled to an edge of the wire harness 7. The detection terminal is sandwiched between the fastening screw 3A and the nut 32, and fastened to the terminal 3, as shown in FIG. 5. In the illustrated battery pack 100, the fastening screw 3A is inserted into the ring-shaped terminal as the detection terminal 5 and into the bus bar 6, and the detection terminal is fastened to the terminal 3 with the bus bar being placed on the detection terminal. However, the detection terminal does not need to be directly connected to the terminal. The bus bar may include the detection terminal to be connected to the wire harness through the bus bar.

### (Wire Harness 7)

The wire harness 7 includes coated leads, and is connected to the protection circuit, which detects voltages of the battery cells 1 and controls charging/discharging operation of the battery pack. In the case where the battery pack includes a number of battery cells 1, which are arranged side by side, the wire harness 7 is required to include a number of leads, in order to detect voltages of the battery cells 1. In the battery pack, an opening 1C of safety valve is arranged between the positive/negative terminals 3. A discharge duct (not shown) or the like is connected to the opening 1C of safety valve, and arranged between the positive/negative terminals 3. In this battery pack, the wire harness 7 extends outside the terminals 3. Accordingly, the wire harness 7 does not interfere with the discharge duct. In the case where the wire harness 7 includes a number of leads that are arranged in proximity to the terminals 3, it is important to prevent damage to outer coating of the wire harness, which may bring the lead in contact with the terminals 3. The reason that, if one lead to one terminal 3 is brought in contact with another terminal, the battery cells 1 may be short-circuited.

### (Electrically Insulating Separation Wall 11)

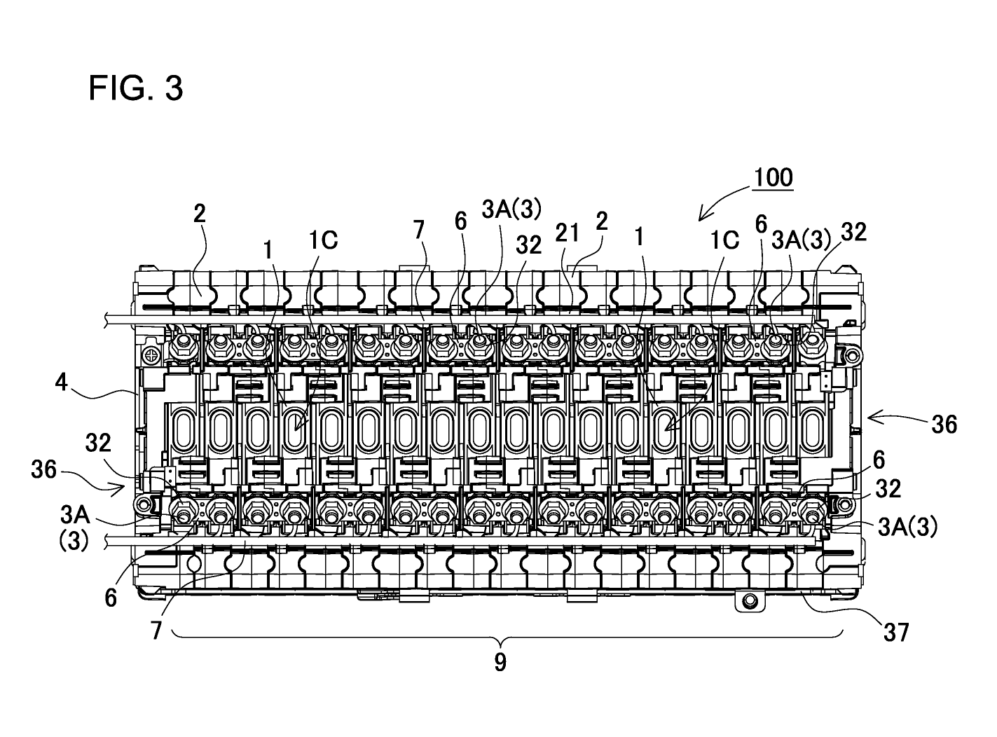

In order to prevent contact of the wire harness 7 with the terminals 3, electrically insulating separation walls 11 are arranged between the terminals 3 and the wire harness 7, and formed of an electrically insulating material. In order to prevent contact between the terminals 3 and the wire harness 7, which may cause short circuit, the electrically insulating separation walls 11 are formed of plastic as the electrically insulating material. In the battery pack 100 shown in FIG. 3, the wire harness 7 extends outside the terminals 3. Correspondingly, the electrically insulating separation walls 11 are arranged outside the terminals 3, and between the terminals and the wire harness 7. Although not illustrated, in the case of a battery pack in which the wire harness extends inside the terminals, the electrically insulating separation walls are arranged inside the terminals so that the wire harness and the terminals are electrically insulated from each other by the electrically insulating separation walls.

### (Harness Cover 10)

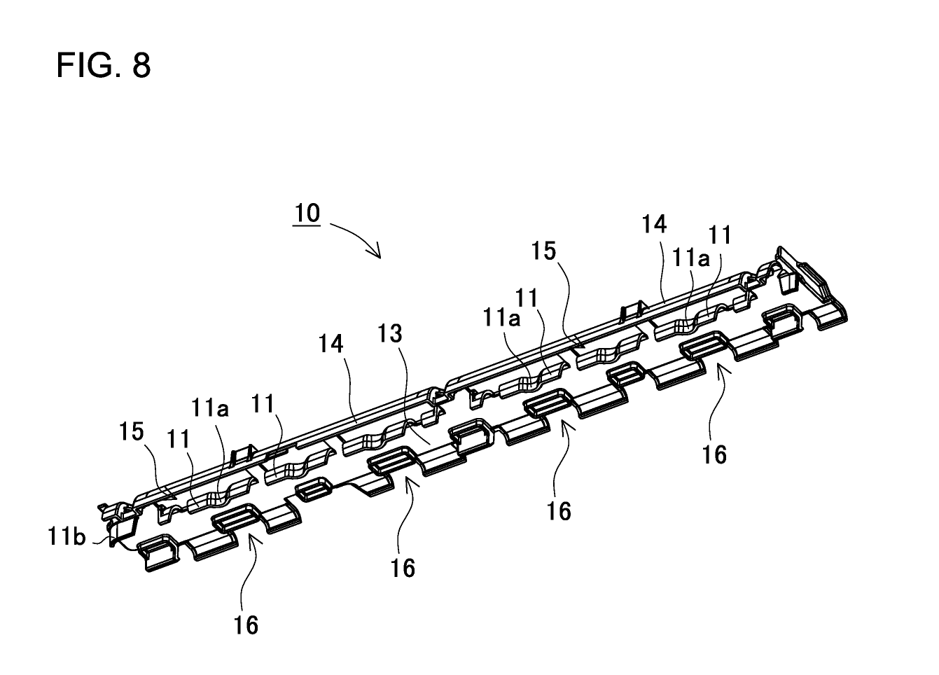

The electrically insulating separation walls 11 shown in FIGS. 5, and 7 to 9 are coupled to each of harness covers 10 formed of plastic. The harness cover 10 is integrally formed with the electrically insulating separation walls 11 by plastic molding as a whole. The harness cover 10 further includes a cover portion 13 that covers the upper surface of the battery pack, and extends to the position where the terminals 3 can be covered. The harness cover is integrally formed also with the terminal cover. Thus, the terminals 3 are covered by the harness cover 10. Accordingly, the terminals can be electrically insulated from metal materials such as an exterior case (not shown) that is arranged above the terminals 3. According to this construction, it is possible to prevent contact between the terminals 3 and the exterior case or the like, which may cause short circuit of the battery cell 1.

In the case where the harness cover 10 integrally is formed with the electrically insulating separation walls 11, the harness cover includes a harness accommodation portion 12 that accommodates the wire harness 7. The harness cover 10 includes cover side walls 14 that are arranged along an outside edge of the cover portion 13 so that the harness accommodation portion 12 is formed between the cover side walls 14 and the electrically insulating separation walls 11. The harness cover 10 accommodates the wire harness 7 in the harness accommodation portion 12, and guides the wire harness into place. The harness cover restricts positional deviation or movement of the wire harness 7, and can further reduce damage to the wire harness 7.

The illustrated harness cover 10 has opening windows 15 in the harness accommodation portion 12. The opening window is formed by opening the cover portion 13 between the cover side wall 14 and the electrically insulating separation walls 11. In the case where the harness cover 10 has the opening windows 15, it is possible to check the extending arrangement of the wire harness 7 when the wire harness is accommodated in the harness accommodation portion 12. The harness cover 10 includes coupling portions that are arranged between the opening windows 15. Thus, the opening windows 15 are formed in the cover portion 13. The coupling portions prevent upward movement of the wire harness 7, which extends in the harness accommodation portion 12. Thus, the wire harness 7 can be held in the harness accommodation portion 12. According to this harness cover 10, it is possible to check the accommodated state of the wire harness 7 in the harness accommodation portion 12 through the opening windows 15. As a result, the wire harness 7 can be reliably positioned in the harness accommodation portion 12. Therefore, it is possible to prevent that the wire harness is caught between the harness cover and the battery block, or the like. In the harness cover 10, the electrically insulating separation wall 11 is connected to an edge of the opening window 15, which is formed in the cover portion 13. In other words, the electrically insulating separation wall extends along one side of the opening window 15. Thus, the opening windows 15 are formed between the electrically insulating separation walls 11 and the cover side wall 14.

As discussed above, in the case where the harness cover 10 has the opening windows 15, the wire harness 7 can be reliably positioned in the harness accommodation portion 12. However, in the case where the harness cover is formed of transparent plastic, even when the opening windows are not provided, operators can check the accommodated state of the wire harness and surely position the wire harness in the harness accommodation portion.

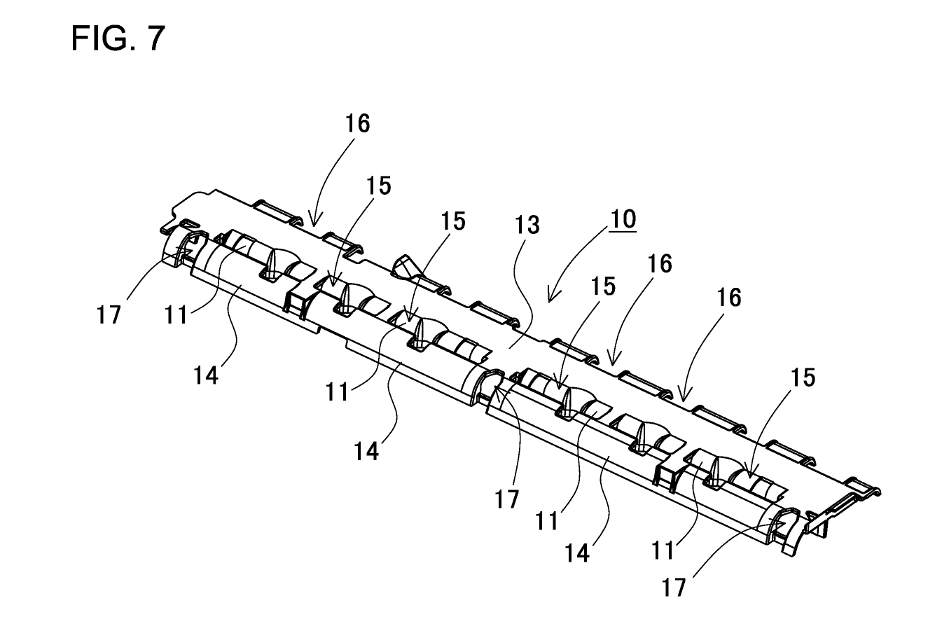

In addition, in the harness cover 10 shown in FIGS. 7 to 9, the electrically insulating separation wall 11 includes a curved part 11a that is formed in a curved shape as viewed in plan view and is interposed between the terminal 3 and the wire harness. The curved shape of the curved part corresponds to the terminal 3. Thus, the space of the harness accommodation portion 12 can be increased. According to this electrically insulating separation wall 11, the wire harness 7 can extend in a curved shape along the curved part 11a. For this reason, when the wire harness 7 extends in a curved shape along the curved part 11a, dimensional deviations and the like of wire harnesses 7 can be tolerated. Also, in the case where the wire harness 7 extends in a curved shape or curved shapes, it is possible to prevent that pulling forces due to vibrations, shocks and the like from vehicles are strongly applied to the wire harness 7. As a result, it is possible to effectively prevent friction or rubbing of the wire harness 7.

The electrically insulating separation wall 11 protrudes from the lower surface of the harness cover 10. As shown in the cross-sectional view of FIG. 5, the electrically insulating separation wall is curved so as to have an inclined part that is inclined relative to the upper surface of the battery cell 1 whereby covering the terminal 3. In the case where the harness cover 10 includes the thus-shaped electrically insulating separation wall 11, when the opening window 15 is formed outside the electrically insulating separation wall 11, the opening window 15 can be large. Accordingly, it is possible to easily check the accommodated state of wire harness 7 through the opening window when the wire harness is accommodated in the harness accommodation portion 12. In addition, it is possible to easily guide the wire harness 7 so as not to be caught by the electrically insulating separation wall 11 when the harness cover 10 is attached.

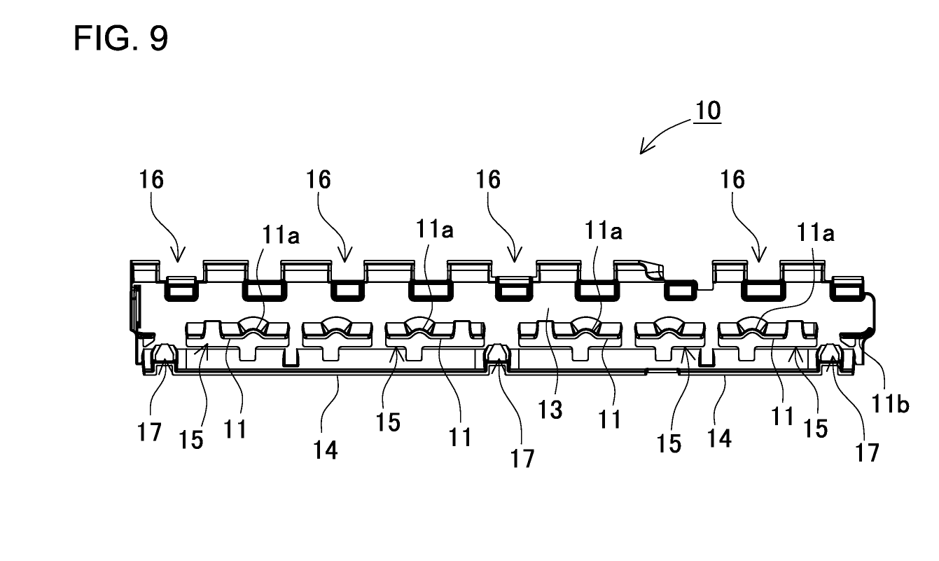

In addition, the electrically insulating separation wall 11 of the harness cover 10 shown in the bottom plan view of FIG. 9 has a curved end part 11b that is arranged on an end of the harness accommodation portion 12 and formed in a curved shape as viewed in plan view. According to this harness cover 10, the wire harness 7 extends in the harness accommodation portion 12, and can be curved along the curved end 11b whereby guiding the wire harness to the outside of the harness accommodation portion 12.

The harness cover 10 is coupled to the separators 2, which are interposed between the battery cells 1, and is arranged in a predetermined position of the battery block 9. The harness cover 10 has coupling recessed portions 16 and coupling openings 17 that are arranged on the both sides of the cover portion 13 and can be coupled to the separators 2 so that the harness cover can be arranged at a predetermined position of each of the separators. The separators 2 include coupling protruding parts 26 and 27 to be guided into the coupling recessed portions 16 and the coupling openings 17. After the coupling protruding parts 26 of the separators 2 are guided into the coupling recessed portion 16, and the coupling protruding parts 27 are guided into the coupling openings 17, the harness cover 10 can be coupled to the separators 2 at the predetermined positions. The separators 2 are sandwiched between the battery cells 1, and arranged at predetermined positions of the battery pack. Accordingly, when the harness cover is coupled to these separators 2 at the predetermined positions, the harness cover 10 can be arranged in place in the battery pack. After coupled the separators 2 at the predetermined positions, the harness cover 10 is pressed by the exterior case (not shown) and the discharge duct (not shown), which are arranged on the harness cover, so that the harness cover can be held at predetermined position of the battery pack. Note that the harness cover may be fastened to end plates or the separators, and arranged at the predetermined position of the battery pack.

In the aforementioned harness cover 10, the cover side walls 14 are arranged along an edge of the opening window 15 so that the harness accommodation portion 12 is formed between the cover side walls 14 and the electrically insulating separation walls 11. According to this harness cover 10, the wire harness 7 can extend along the harness accommodation portion 12.

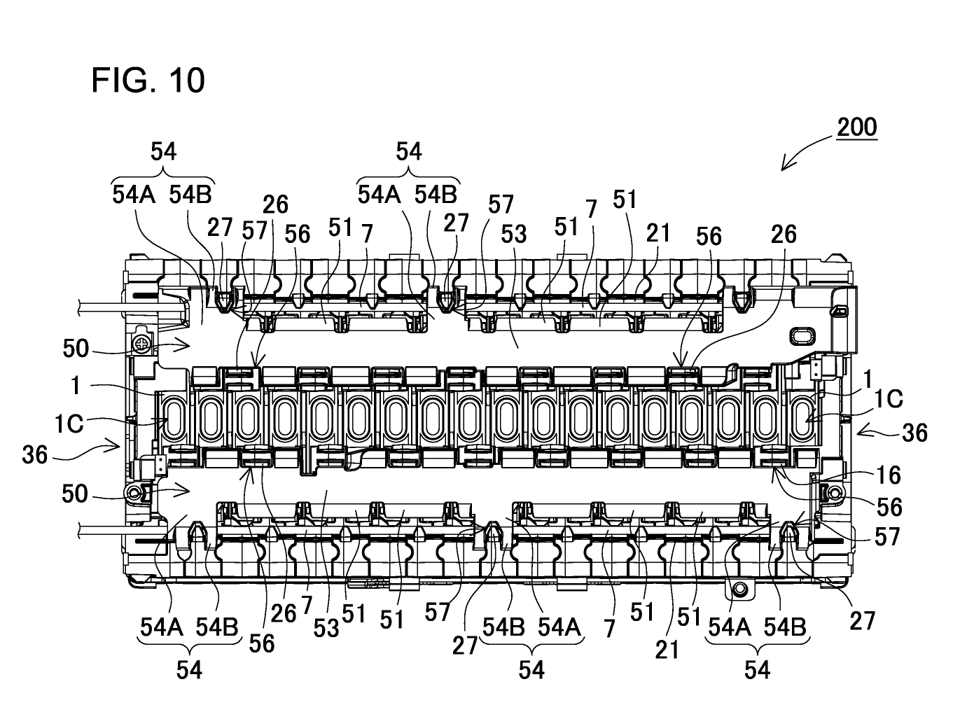

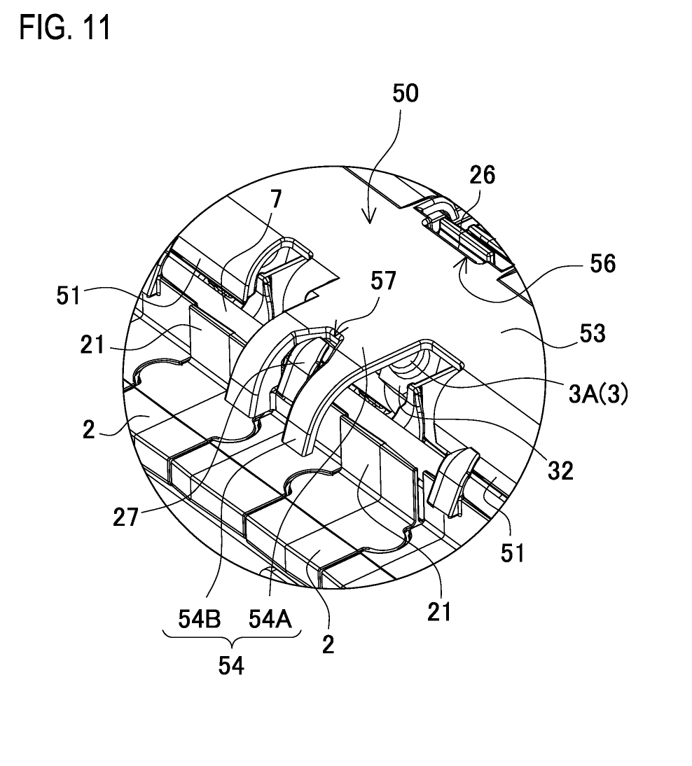

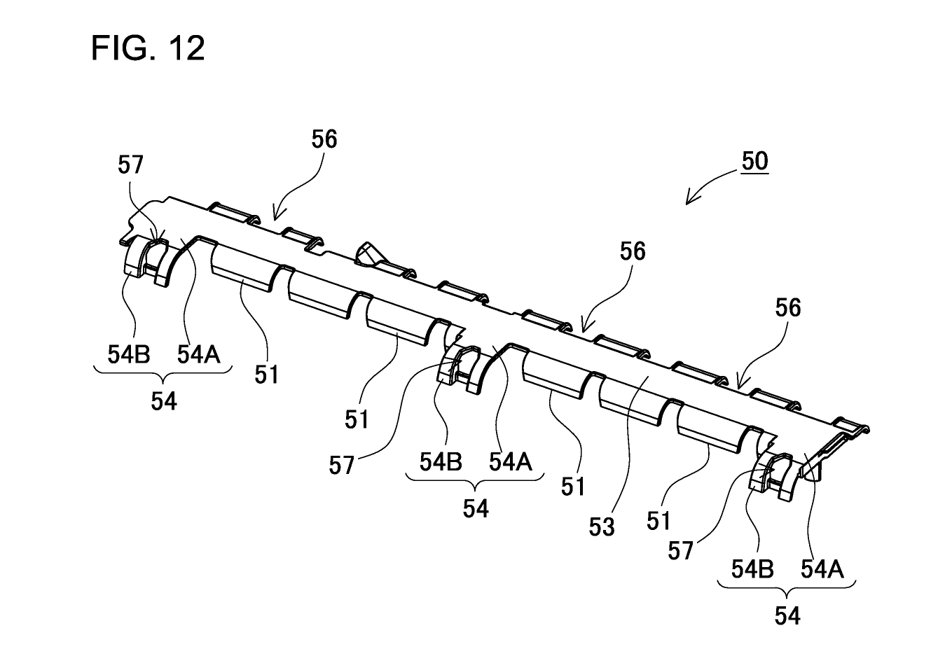

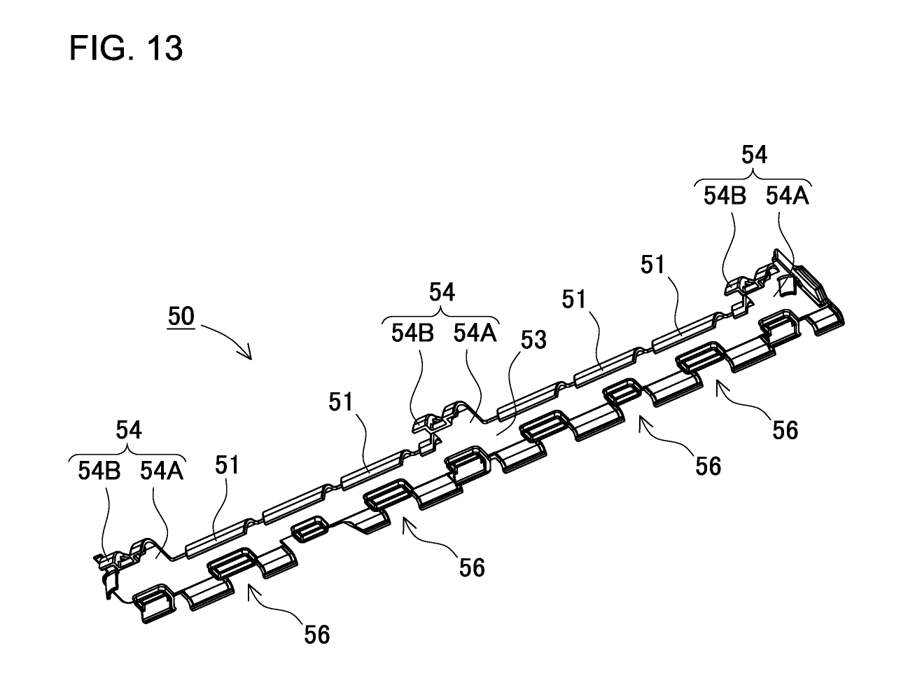

Each of harness covers 50 of a battery pack 200 shown in FIGS. 10 to 13 includes cover side walls 54, which are arranged only in the both end parts and the central part of the harness cover 50. The wire harness 7 can extend outside the electrically insulating separation wall 51. In the illustrated harness cover 50, the cover side walls 54 protrude outward of the both end parts and the central part of an outside edge of the cover portion 53. The illustrated cover side wall 54 includes a horizontal portion 54A and a side wall portion 54B. The horizontal portion protrudes outward of the outside edge of the cover portion 53. The side wall portion is arranged on the end of the horizontal portion 54A. In this battery pack, the separator 2 includes vertical walls 21 to be arranged outside the electrically insulating separation walls 51 of the harness covers. The vertical walls are integrally formed with the separator. The wire harness 7 extends between the vertical walls 21 of the separators and the electrically insulating separation walls 51 of the harness cover. In this battery pack, the wire harness 7 is partially covered and held in place by the cover side walls 54 of the harness cover 50. The side wall portion 54B of the illustrated cover side wall 54 can be arranged outside the vertical wall 21. The harness cover 50 also has coupling recessed portions 56 and coupling openings 17 to be coupled to the separators 2 so that the harness cover can be arranged at a predetermined position of each of the separators. The coupling recessed portions 56 are arranged on the inside part of the cover portion 53, while the coupling openings 57 are opened in the cover side walls 54. After the coupling protruding parts 26 of the separators 2 are guided into the coupling recessed portion 56, and the coupling protruding parts 27 are guided into the coupling openings 57, the harness cover 50 can be also coupled to the separators 2 at the predetermined positions.

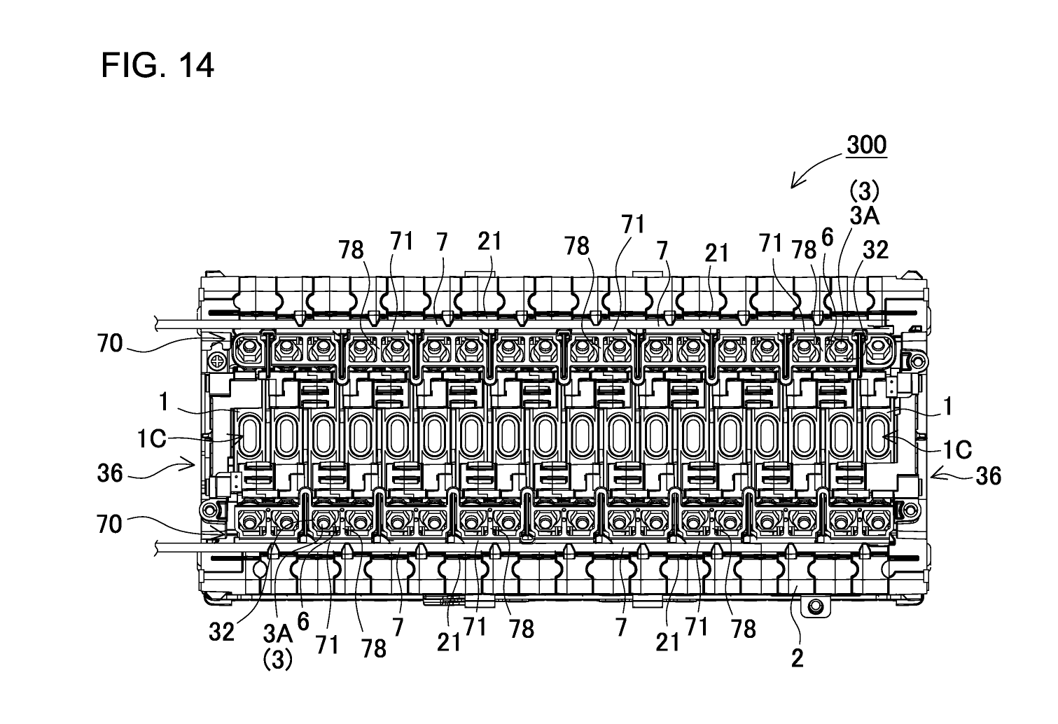

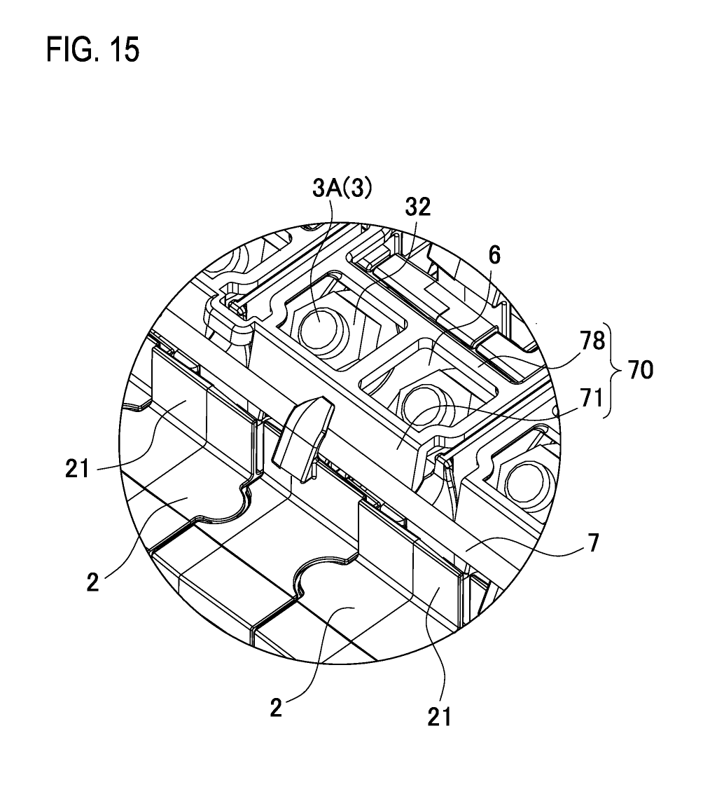

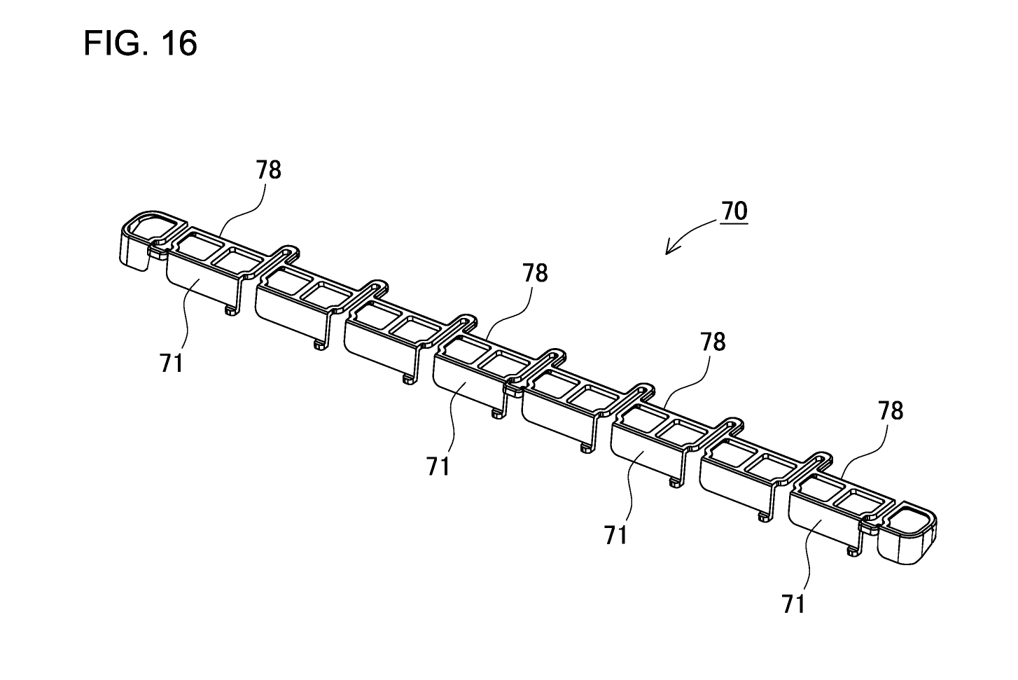

In a battery pack 300 shown in FIGS. 14 to 16, electrically insulating separation walls 71 are not integrally formed with each of harness covers 70 but are coupled to frame members 78. The electrically insulating separation wall 71 is coupled to the frame member 78, which has an eyeglasses-frame shape and is arranged above the terminals 3. The adjacent eyeglasses-frame-shaped frame members 78 are coupled to each other. As for the electrically insulating separation wall 71, the electrically insulating separation walls 71 and the eyeglasses-frame-shaped frame members 78 are integrally formed with each other of plastic. When the eyeglasses-frame-shaped frame members 78 are coupled in place to the battery block 9, the electrically insulating separation walls 71 can be arranged between the wire harness 7 and the terminals 3. The eyeglasses-frame-shaped frame members 78 can be coupled in place to the terminals 3 or to the separators 2 so that the frame members can be coupled in place to the battery block 9. Alternatively, the frame members can be coupled in place to the end plates 36. According to the electrically insulating separation walls 71, it is possible to visually check the accommodated state of the entire wire harness. It is possible to avoid the drawback that the wire harness 7 is caught by the electrically insulating separation wall 71, or the like.

### (Separator 2)

The separators 2 are sandwiched between the battery cells 1. When the separator 2 is sandwiched between the battery cells 1 adjacent to each other, the adjacent battery cells 1 are spaced at a predetermined interval away from each other, and are electrically insulated from each other. To achieve this, the separator 2 is formed of eclectically-insulating material. Thus, the separator electrically insulates the exterior containers 1A of the adjacent battery cells 1 from each other. The separator 2 can be formed of an electrically-insulating material such as plastic by molding. In addition, gas-flowing gaps can be formed between the opposed surfaces of the adjacent battery cells 1. In this case, gas for cooling of the battery cell 1 can flow along the gaps.

The illustrated separator 2 is integrally formed. However, the separator may be constructed of a plurality of separated members. In the case where the separator is constructed of a plurality of separated members, the separator can include an electrically insulating sheet member, and a pair of separated side members, for example. The sheet member is arranged between the opposed surfaces of the adjacent battery cells. The sheet member is interposed between the separated side members, which are arranged on the both sides of the sheet member.

The separator 2 includes frame portions 22 that can hold outer peripheral parts of the battery cells 1. The side part of the separator is opened between the frame portions 22. Vertical and horizontal frame parts 22A and 22B are provided as the frame portions 22. The vertical frame parts partially extend along the both sides of the battery cell 1. The horizontal frame parts extend along the upper and lower edges of the separator. Thus, the vertical and horizontal frame parts can serve to hold a rectangular member. Each of the vertical and horizontal frame parts 22A and 22B has a plate shape that extend along one of the outer peripheral surfaces of the battery cell 1. The vertical frame parts 22A have a width that allows two separators to cover the overall width of the both side surfaces of one of the battery cells 1 when the separators are sandwiched between the battery cells 1. The horizontal frame parts 22B serve as horizontal parts that extend along the upper and lower surfaces of the battery cell 1. One of the horizontal parts has a shape that does not overlap the terminals 3 and the opening 1C of safety valve, which is arranged on the upper surface of the battery cell 1 whereby exposing the terminals 3 and the opening 1C of safety valve. The horizontal part, which can extend along the lower surface of the battery cell 1, is constructed so that, when the battery cell 1 is sandwiched between the horizontal parts of the two separators, the horizontal parts can cover the lower surface of the battery cell 1. When the battery cells 1 are sandwiched between the thus-constructed separators 2 from the both main surfaces of the battery cells, the separators 2 cover the both main surfaces and lower surface of the battery cells 1 whereby electrically insulating the side-by-side-arranged battery cells from each other.

Thus, the battery block 9 is constructed of the battery cells 1 and the separators 2, which are alternately arranged on each other. The battery cells and the separators are securely held in place by fastening members. The fastening members include a pair of end plates 36, and metal binding bars 37. The end plates are arranged on the both end surfaces of the battery block of the battery cells, which are arranged side by side. The ends of the binding bar are coupled to the end plates 36 so that the battery cells 1 are arranged side by side and pressed from the both end surface sides of the battery block.

### (End Plate 36)

The end plates 36 are arranged on the both end surfaces of the battery block 9, and cover the separators 2 that are located on the both end sides of the battery block 9. The end plates 36 are coupled to the both end sides of the battery block 9 by bolts 38, and the like. The end plate 36 is formed of hard plastic, or metal such as aluminum or aluminum alloy. The end plate 36 has substantially the same exterior rectangular shape as the battery cell 1 so that the contact area of the end plate with the battery cell 1 can be large. The rectangular end plate 36 has the same size as the rectangular battery cell 1, or a slightly larger size than the battery cell 1. In the case where the end plate is formed from plastic, the end plate 36 is directly fastened to the battery cell 1. In the case where the end plate is formed from metal, the end plate is fastened to the battery cell with an interposition member being interposed between the end plate and battery cell.

In the embodiment shown in FIGS. 1 to 4, the separator 2 that faces the end plate 36 includes a protrusion 23 that protrudes toward the end plate 36, while the end plate 36 has a protrusion insertion opening 36A into which the protrusion 23 is inserted. The protrusion insertion opening 36A is not arranged at a position symmetric with respect to a line but a position asymmetric with the central line of the end plate 36. The asymmetric position refers to a position on the end plate 36 that is rotated from an original position by rotating the end plate at 180 degrees and does not agree with the original position after the rotation. According to this construction, the separator 2 and the end plate 36 can be arranged in desired orientation relative to each other by the protrusion 23 and the protrusion insertion opening 36A. As a result, it is possible to prevent that the end plate 36 is wrongly orientated, that is, orientated upside down.

### (Metal Band 37)

The ends of the metal bands 37 are coupled to the end plates 36. The metal bands 37 are coupled to the end plates 36 by the bolts 38. Although the metal bands 37 shown in FIG. 4 are coupled to the end plates 36 by the bolts 38, the metal bands may be coupled to the end plates by bending the ends of the metal bands inward or by caulking the ends of the metal band.

The metal bands 37 can be formed by the working of a metal plate having a predetermined thickness into a metal band having a predetermined width. The ends of the metal bands 37 are coupled to the end plates 36. Thus, the pair of end plates 36 are coupled to each other through the metal bands so that the battery cells 1 is brought and held in press contact with each other. The pair of end plates 36 are fixed at a predetermined interval away from each other by the metal bands 37 so that the battery cells 1, which are arranged side by side between the end plates, are held in a predetermined press contact state. If the metal bands 37 expand when the expansion pressure of the battery cell 1 is applied to the bind bars, the metal bands cannot prevent expansion of the battery cell. For this reason, the metal bands 37 are formed by the working of a metal plate that has sufficient stiffness to prevent expansion when the expansion pressure of the battery cell 1 is applied, for example, a metal plate of stainless plate such as SUS304 or a steel plate, into a metal band having a width and a thickness that can provide sufficient stiffness. Alternately, the metal bands may be formed the working of a metal plate into a metal band having a groove shape. Since the thus-shaped metal bands can have a high stiffness against bending, even in the case where the width of the metal bands is small, the rectangular batteries can be arranged side by side and securely held in the predetermined press contact state. The metal band 37 includes bent parts 37A that are arranged on the ends of the metal band. The bent parts 37A are coupled to the end plates 36. The bent part 37A has a through hole for receiving the bolt 38. The bolts 38 are inserted into the through holes, and screwed to the end plates 36 so that the metal band is fastened to the end plates.

In the battery block 9 shown in the perspective views of FIGS. 1 and 4, two metal bands 37 are arranged on the upper and lower parts of each of the both side surfaces of the battery block 9 so that both the end plates 36 are coupled to each other through the upper and lower metal bands. In this thus-constructed battery block 9, the end plates 36 can be firmly coupled to each other through two pairs of metal bands 37. However, the metal band according to the present invention is not limited to the construction according to this embodiment. For example, two metal bands that are arranged on the upper and lower parts may be integrally formed with each other.

The aforementioned battery pack 100 is installed on a power supply device for vehicles. Although not illustrated, the power supply device including the battery pack 100 further includes a plurality of temperature sensors, a forcedly-air-blowing mechanism, and a control circuit. The plurality of temperature sensors detects temperatures of the battery cells 1. The forcedly-air-blowing mechanism blows cooling gas into an air duct in accordance with the detected temperatures of the battery cells 1, which are detected by the temperature sensors. The cooling gas flows through the air duct and branches into the gas-flowing gaps. The control circuit controls a current of the battery based on the detected temperatures of the battery cells 1, which are detected by the temperature sensors.

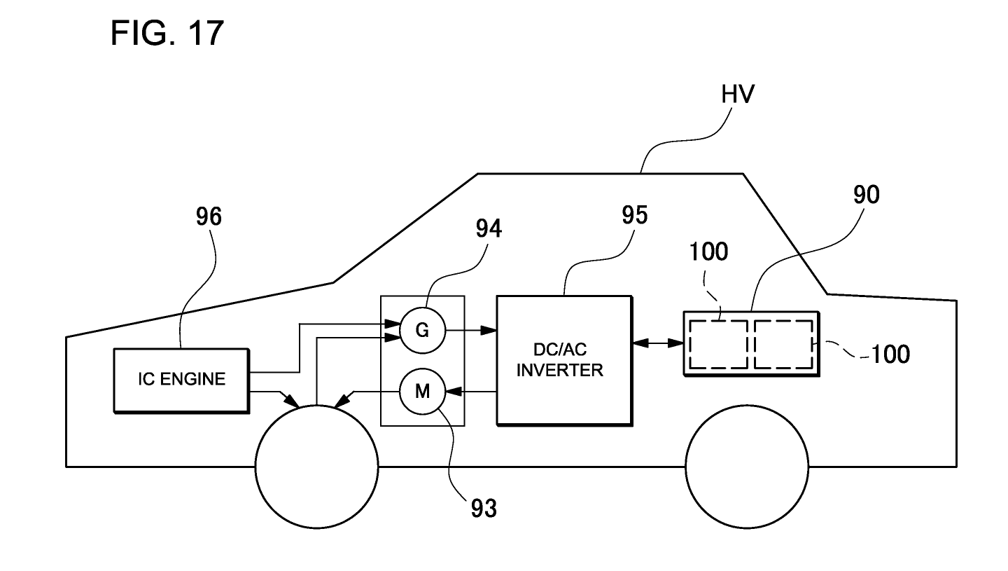

FIG. 17 is a block diagram showing an exemplary hybrid car that is driven both by an engine and an electric motor, and includes a power supply device 90. The illustrated vehicle HV with the power supply device 90 includes an electric motor 93 and an engine 96 that drive the vehicle HV, the power supply device 90 that includes the battery packs 100 and supplies electric power to the electric motor 93, and an electric generator 94 that charges batteries of the battery packs 100. The power supply device 90 is connected to the electric motor 93 and the electric generator 94 via a DC/AC inverter 95. The vehicle HV is driven both by the electric motor 93 and the internal-combustion engine 96 with the batteries of the power supply device 90 being charged/discharged. The electric motor 93 is energized and drives the vehicle in a poor engine efficiency range, e.g., in acceleration or in a low speed range. The electric motor 93 is energized by electric power that is supplied from the power supply device 90. The electric generator 94 is driven by the engine 96 or by regenerative braking during vehicle braking so that the batteries of the power supply device 90 are charged.

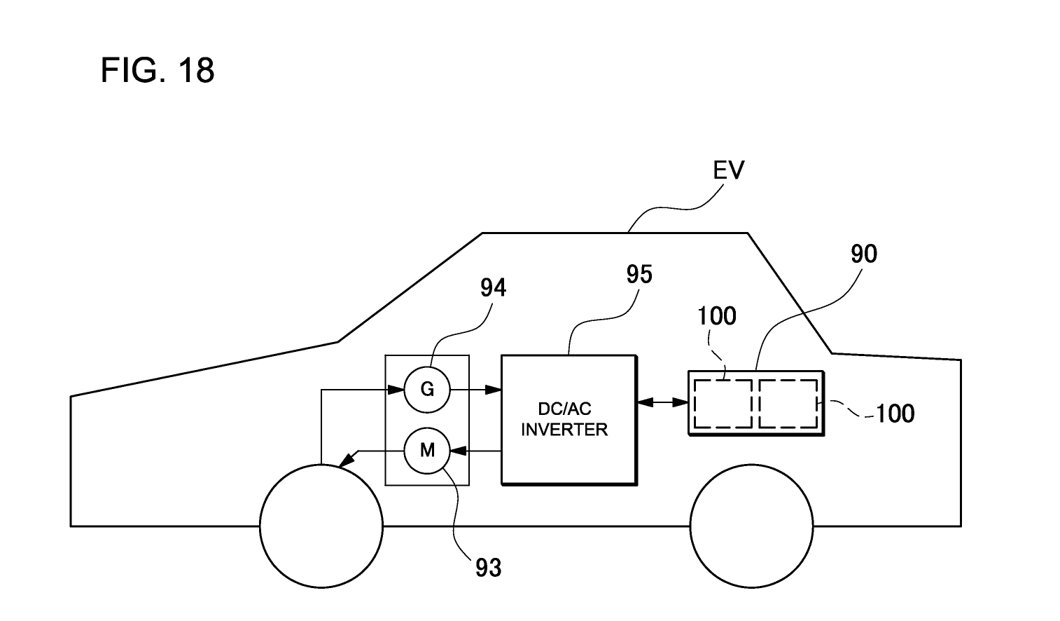

FIG. 18 shows an exemplary electric vehicle that is driven only by an electric motor, and includes the power supply device 90. The illustrated vehicle EV with the power supply device 90 includes an electric motor 93 that drives the vehicle EV, the power supply device 90 that includes the battery packs 100 and supplies electric power to the electric motor 93, and an electric generator 94 that charges batteries of the battery packs 10. The power supply device 90 is connected to the electric motor 93 and the electric generator 94 via a DC/AC inverter 95. The electric motor 93 is energized by electric power that is supplied from the power supply device 90. The electric generator 94 can be driven by vehicle EV regenerative braking so that the batteries of the power supply device 90 are charged.

A battery pack, a vehicle including the battery pack and a battery pack binding bar according to the present invention can be suitably used for vehicle battery system for electric cars or hybrid cars. Also, the present invention can be suitably applied to power supply devices other than vehicle power supply device.

1-9. (canceled)

10. A battery pack comprising:
a plurality of battery cells that include terminals on the upper surfaces of the battery cells;
bus bars that connect the terminals of the battery cells to each other with said plurality of battery cells being arranged side by side;
an electrically insulating separation wall that is arranged between said terminal and said wire harness; and
a harness cover that covers said terminals and said wire harness,
wherein harness cover includes a harness accommodation portion that accommodates said wire harness, and said electrically insulating separation wall,
wherein the upper surfaces of the battery cells are covered by said harness cover.

11. The battery pack according to claim 10, wherein said harness accommodation portion has an opening window.

12. The battery pack according to claim 10, wherein said electrically insulating separation wall has a curved part corresponding to said terminal.

13. The battery pack according to claim 10, wherein said electrically insulating separation wall and said harness accommodation portion are integrally formed as the harness cover.

14. The battery pack according to claim 11, wherein said electrically insulating separation wall and said harness accommodation portion are integrally formed as the harness cover,
wherein said electrically insulating separation wall is connected to an edge of said opening window,
wherein said electrically insulating separation wall has an inclined part that is inclined relative to the upper surface of said battery cell.

15. The battery pack according to claim 10, wherein said electrically insulating separation wall has a curved part that is arranged on an end of the harness accommodation portion and formed in a curved shape as viewed in plan view.

16. The battery pack according to claim 13, further comprising a plurality of electrically insulating separators that are interposed between said battery cells adjacent to each other,
wherein said harness cover is coupled to said separators.

17. A vehicle comprising the battery pack according to claim 10.
